(19) United States
(12) Patent Application Publication
(10) Pub. No.: US 2016/0380444 A1
(43) Pub. Date: Dec. 29, 2016

(54) METHOD FOR MANAGING THE ENERGY PRODUCTION OF AN ENERGY SYSTEM AND ASSOCIATED MANAGEMENT DEVICE

(71) Applicant: COMMISSARIAT A L'ENERGIE ATOMIQUE ET AUX ENERGIES ALTERNATIVES, Paris (FR)

(72) Inventors: Franck Al Shakarchi, Saint-Sulpice (FR); Hervé Guillou, Paris (FR)

(73) Assignee: COMMISSARIAT A L'ENERGIE ATOMIQUE ET AUX ENERGIES ALTERNATIVES, Paris (FR)

(21) Appl. No.: 15/184,569

(22) Filed: Jun. 16, 2016

(30) Foreign Application Priority Data
Jun. 23, 2015 (FR) 15 55762

(51) Int. Cl. H02J 7/00

(52) U.S. Cl. CPC H02J 7/0016; H02J 7/0021; H02J 7/007; H02J 2007/0096

(57) ABSTRACT

The energy system incorporates an energy production device (2) and a plurality of energy storage modules (3A-3D). The method comprises the following steps implemented by the management device (4): formulation of a forecast plan for production of energy output by the system for a future period, and incorporation (E5) of at least one related operation on a storage module in the production plan of the system. The incorporation of a related operation on a storage module in the production plan comprises the formulation of a forecast plan for operation of the storage module containing setting to an initial state of charge required for the related operation, a step for execution of a power profile of the related operation and stoppage of the said execution step when a criterion for stoppage of the related operation is satisfied.

The invention relates to the management of the production of an energy system comprising an energy production device, or energy source, a plurality of energy storage modules and a control device intended to control the storage of energy and the production of energy output by the system.

Certain energy production systems, or plants, produce energy, for example electric energy, by means of conversion of a renewable energy such as solar energy or wind energy. The electric energy produced is supplied to an electric power supply network. Renewable energy is most often of an intermittent nature: it is not continuous or uniform over time. It may be necessary or useful to control the production of electric energy output by the system, or the plant, with the aim for example of ensuring the stability of the electric power network or supplying the electric energy produced during a pricing period which is favourable for the system or plant operator. In order to ensure a certain flexibility as regards the production of energy by the upstream energy production device (photovoltaic modules, wind modules, etc.) and the production of energy output by the system, the latter incorporates energy storage modules. During operation, the energy production device produces electric energy depending on the quantity of renewable energy received. This electric energy is either directly supplied to the electric power network or provisionally stored by the storage modules and then further supplied to the electric power network.

In order to better manage the storage of the energy and the production thereof output by the system, operation of the system is generally pre-programmed by means of an energy production plan. This production plan is established on the basis of the hypothetical production of energy by the source. It covers a reference time period, for example 24 hours, and is intended to be applied during a corresponding future period. The production plan is defined by:
a power plan indicating the trend of the power output by the system during the reference period and
a state-of-charge plan indicating the trend of the overall state of charge (or state of energy, “SoE”) of the storage modules.

During operation, the storage of energy and the production of energy output by the system are controlled on the basis of this production plan.

During the working life of the energy production system, it may prove necessary to carry out certain further operations, in addition to the normal operation of the system, in particular on the storage modules. These complementary further operations, which we called “related operations”, may comprise tests, calibration, maintenance operations, balancing operations, or other operations.

At present, these related operations are carried out either “off-line” on at least part of the production plant, which is disconnected and therefore does not participate momentarily in the overall energy production, or “on-line” (namely during energy production) in an opportune manner if a favourable situation arises and a related operation may be carried out.

The present invention aims to improve the situation.

To this end, the invention relates to a method for managing, by means of a management device, the energy production of an energy system incorporating an energy production device and a plurality of energy storage modules, comprising a step for formulation, by the management device, of a forecast plan for production of energy output by the system for a future period, characterized in that it comprises a step for incorporation, by the management device, of at least one related operation on a storage module in the production plan of the system.

As a result of the invention, during energy production by the production system on the basis of the established production plan, one or more related operations are carried out on one or more storage modules, the latter also participating in the overall production of the system.

Advantageously, the incorporation, in the production plan, of a related operation on a storage module comprises the formulation of a forecast plan for operation of the storage module containing setting to an initial state of charge required for the related operation, a step for execution of a power profile of the related operation and stoppage of the said execution step when a criterion for stoppage of the related operation is satisfied.

Again advantageously, the method comprises a step of recording at least one related operation profile in a database of the management device, the said profile containing an initial state of charge required for the storage module, a power profile comprising data relating to the power time trend of the storage module, and a criterion for stoppage of the related operation.

According to a first embodiment, the step of formulation of a production plan and the step of incorporation of at least one related operation on a storage module in the production plan of the system are performed in a combined manner.

According to a second embodiment, the step of incorporation of at least one related operation on a storage module in the production plan of the system is performed after the step of formulation of a production plan.

Advantageously, the step of formulation of a production plan and the step of incorporation of at least one related operation on a storage module in the production plan are performed by the management device via execution of an optimization software.

In this case, again advantageously, the method comprises a step of specification of functions to be optimized, at least one of the functions being to incorporate at least one related operation in the operation of at least one storage module.

In a particular embodiment, the incorporation of a related operation on a storage module is achieved by performing charging or discharging compensation with at least one other storage module.

In another particular embodiment, the incorporation of a related operation on a storage module is performed by modification of a pre-established production plan within a given tolerance margin.

The related operation may be an operation of the group comprising the related operation is one of the operations from the group comprising:
a first charging capacity test consisting in performing complete charging, at constant charging power, of the storage module followed by complete discharging, at constant discharging power, of the storage module.
a second charging capacity test consisting in performing complete charging, at several charging power levels, of the storage module followed by complete discharging, at several discharging power levels, of the storage module,
balancing of the storage module characterized by charging, at a fixed charging power less than or equal to a maximum power and for a duration greater than or equal to a minimum duration,
a maintenance operation characterized by an inactivity of the storage module for a given duration.

In one particular embodiment, the energy production device is of the intermittent type and the production plan is established on the basis of an estimate of energy production by the energy production device during the future period.

The invention also relates to a device for managing an energy production system incorporating an energy production device and a plurality of energy storage modules, comprising a tool for formulation of a forecast plan for production of energy output by the system for a future period, characterized in that the tool for formulation of the production plan comprises a module for incorporation of at least one related operation on a storage module in the production plan of the system.

Advantageously, the incorporation module is designed to formulate a forecast plan for operation of the storage module containing setting to an initial state of charge required for the related operation, a step for execution of a power profile of the related operation and stoppage of the said execution step when a criterion for stoppage of the related operation is satisfied.

Again advantageously, it comprises a database for storing at least one related operation profile, the said profile containing an initial state of charge required for the storage module, a power profile comprising data relating to the power time trend of the storage module, and a criterion for stoppage of the related operation.

The invention will be better understood with the aid of the following description of a particular embodiment of the method for managing the energy production of an energy system and a management device for implementing the method, with reference to the attached drawings in which:

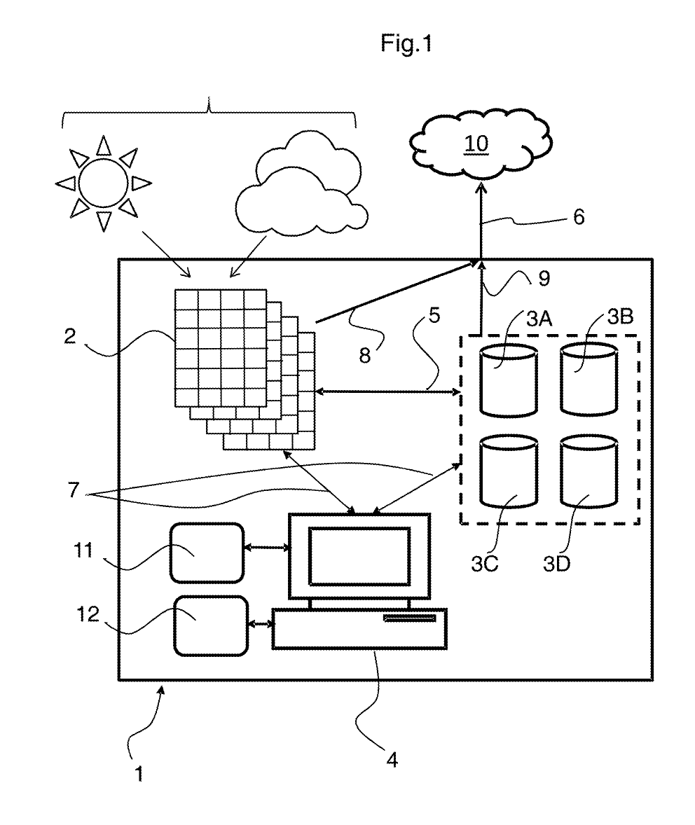

FIG. 1 shows an energy production system according to a particular embodiment of the invention;

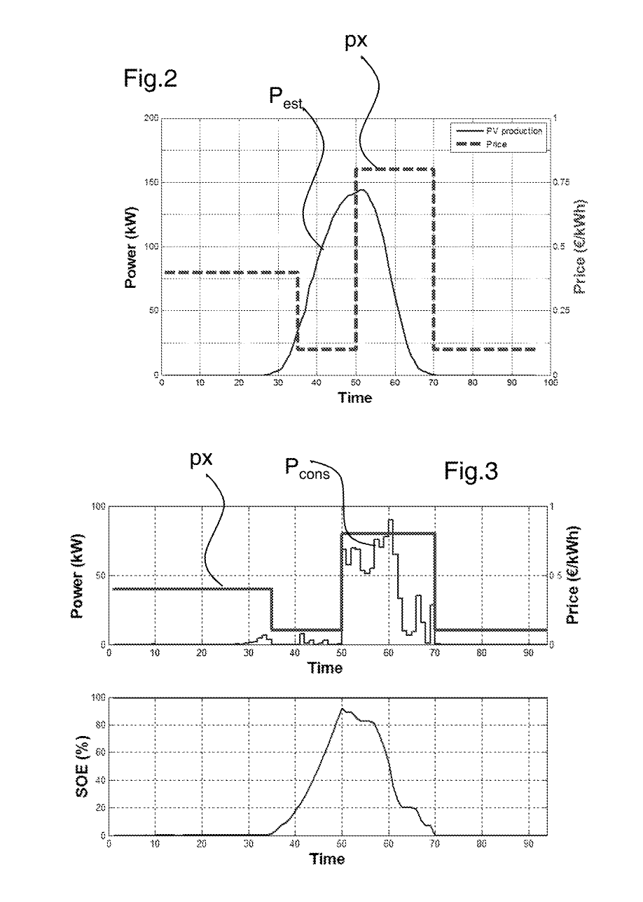

FIG. 2 shows an estimate of the production of energy by an upstream energy production device of the system according to FIG. 1 and the trend of the price of energy during a reference period;

FIG. 3 shows a forecast plan for production of energy by the system according to FIG. 1;

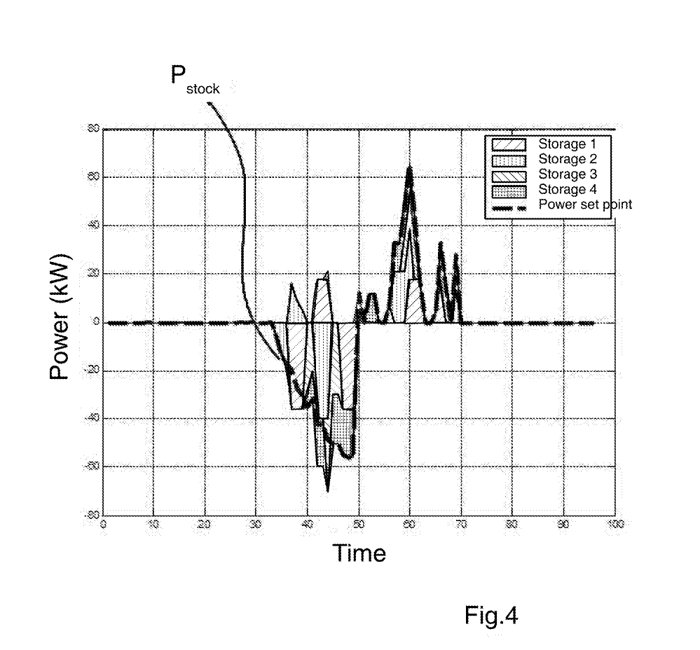

FIG. 4 shows a power plan for a set of storage modules of the system according to FIG. 1 broken down into the individual contributions of the different storage modules;

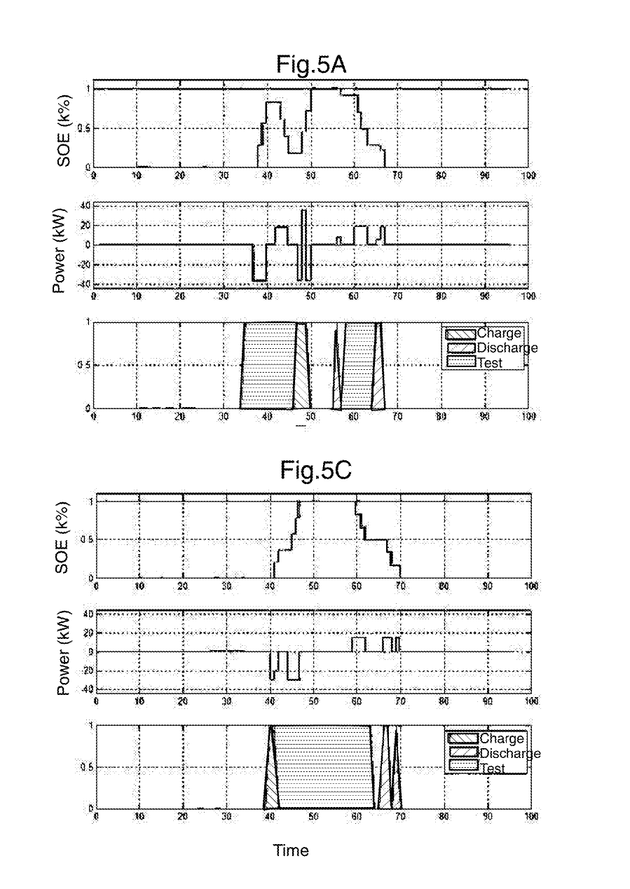

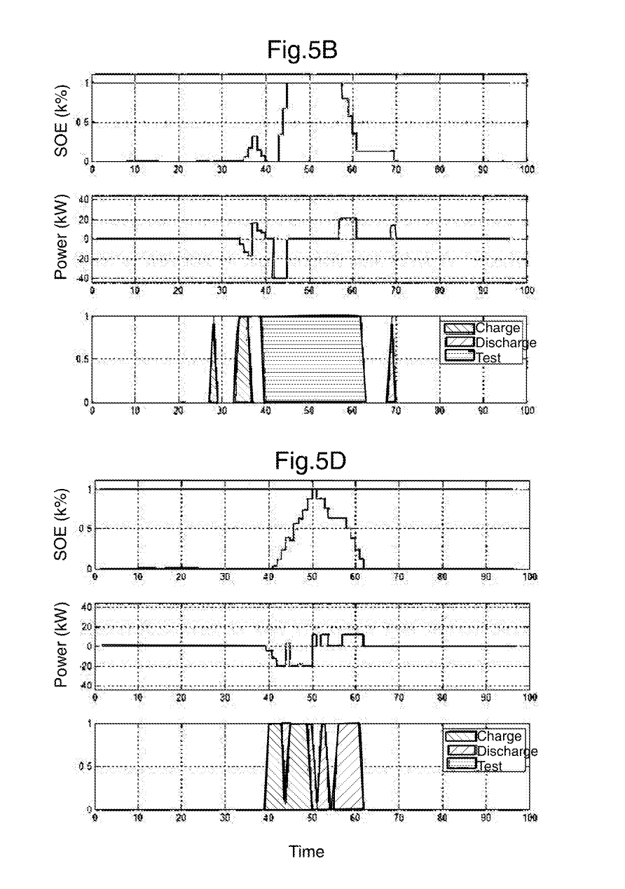

FIGS. 5A to 5D show forecast plans for operation of the energy storage modules;

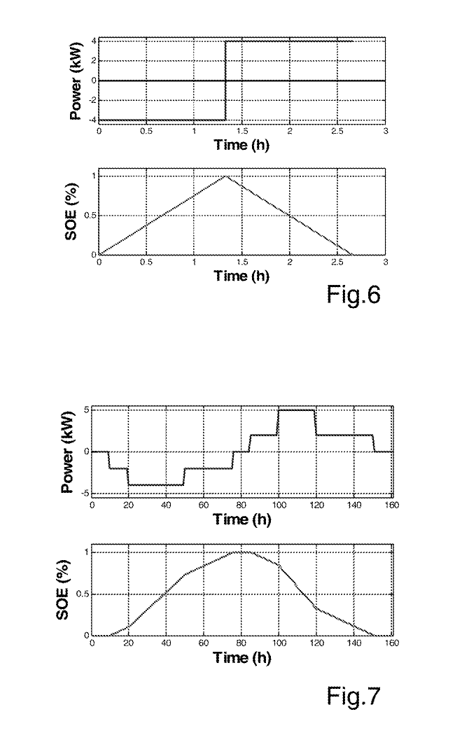

FIGS. 6 to 9 show different examples of profiles of related operations;

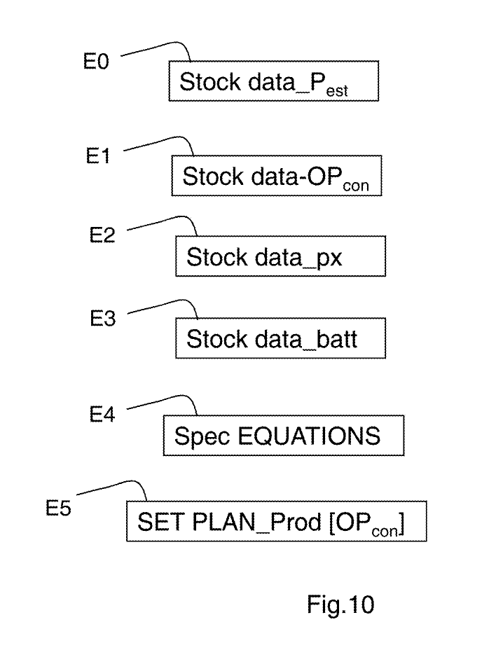

FIG. 10 shows a flow chart of the steps of the management method of the invention, according to a particular embodiment;

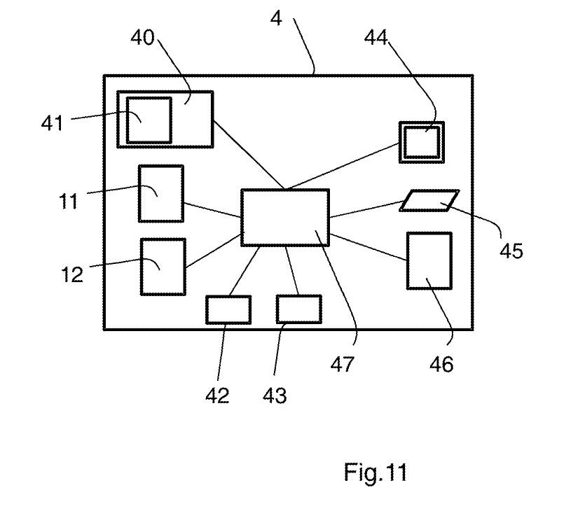

FIG. 11 shows a functional block diagram of a management device of the energy production system.

FIG. 1 shows an energy production system 1 comprising an upstream energy production device 2, a plurality of energy storage modules 3A-3D and a management device 4 for managing the energy production of the system 1.

The upstream energy production device 2 comprises N energy source(s), with N≧1. In this case, the device 2 comprises N energy sources able to convert a first energy such as a renewable energy (solar energy, wind energy, or the like) into a second energy, for example electric energy. The energy produced by the energy sources is here temporarily intermittent, which means that it is not constant and uniform over time. In the example of embodiment described here, the energy production device 2 comprises N photovoltaic modules which are connected together and intended to convert solar energy into electric energy. The energy production device 2 is referred to as being “upstream” since it produces the energy upstream of the energy production output 6 of the system 1.

The system 1 comprises M energy storage devices 3A-3D, here batteries, with M greater than 1. In the example shown here, M is equal to 4. These M storage devices 3A-3D are connected by means of an electrical connection 5 to the energy production device 2.

The system 1 comprises an output 6 which is connected to an electric power network 10 and via which the system 1 is intended to introduce electric energy into the network 10. The upstream energy production device 2 and the energy storage modules 3A-3D are respectively connected to the output 6 by two respective electric connections 8 and 9.

The upstream energy produced by the device 2 is either directly supplied to the electric power network 10 via the output 6 of the system 1 or provisionally stored in the storage modules 3A-3D of the system 1, as will be explained further below.

The management device 4 is intended to manage storage of the electric energy produced by the upstream production device 2 and the production of electric energy at the output 6 of the system 1. The energy storage and the production of energy at the output 6 of the system 1 (otherwise referred to as the introduction of electric energy into the electric power network 10) are controlled by the management device 4 on the basis of a production forecast plan.

The production forecast plan is formulated by a tool 40 of the management device 4. It covers a reference time period, for example 24 hours.

The production forecast plan corresponds to a desired or target operation of the energy production system 1 during a future period corresponding to the reference period which here covers 24 hours. It comprises:
a production power plan containing data relating to the time trend of a desired or set power level, P_{cons}, at the output 6 of the system 1 during the reference period;
a corresponding overall state-of-charge or state-of-energy (SoE) plan containing data relating to the time trend of a desired or set overall state of charge (or state of energy) of all the storage modules 3A-3D during the reference period.

A certain tolerance margin may be defined with regard to the set production power levels and the set states of charge of the storage modules. For example, the tolerance margin may be + or −5% of the set power for the power plan or + or −5% of the set state of charge.

FIG. 3 shows an example of a production plan for the production system 1.

The production plan is established on the basis of data relating to an estimate of electric energy production by the energy production device 2 during a future time period corresponding to this reference period. FIG. 2 shows the time trend of the estimated power level Pₑₛₜ for a reference period of 24 hours. The period starts at an instant indicated “0” corresponding to the time “0 hours” (or midnight) and terminates at the instant indicated “100” corresponding to the time 24 hours (or midnight), the instant indicated “50” corresponding to the time 12 hours (or midday), and the hours being expressed in solar time.

The graph “px” shown as a broken line in FIG. 2 corresponds to the time trend of the price of electricity over the reference period 0-100.

The method for managing the energy production according to the invention comprises a first step E0 of recording data, “data _Pₑₛₜ”, relating to the estimate of the electric energy production by the energy production device 2 during the reference period, in a database 11 of the management device 4. The data “data_Pₑₛₜ” may be entered by a user via a user interface of the management device 4 which stores them in the database 11.

According to the invention, the method for managing the production of the system 1 comprises a step of incorporating related operations on storage modules 3A-3D in the production plan, as will be explained further below. A “related operation on a storage module” is an operation where the storage module is required to perform one or more actions having an aim other than that of contributing to the production of energy by the system 1. This different aim may be in addition to or instead of the aim of contributing to produce energy at the output of the system 1. A related operation on a storage module may be a (complete or partial) charging test and/or (complete or partial) discharging test, a balancing operation, a maintenance operation or any other operation affecting the storage module.

A related operation is characterized by different elements comprising:
an initial state of charge;
a power profile consisting of data relating to the time profile of the (charging and/or discharging) power of the storage module, this data being able to be represented by means of a power graph;
a criterion for stoppage of the operation;
optionally the possibility of including pauses within the power profile in order to facilitate incorporation thereof in the production plan of the system;
optionally an economic value.

The method for managing the energy production according to the invention comprises a second step E1 of recording a set of related operation profiles in a database 12 of the management device 4. Each related operation profile contains the characteristic data relating to this operation, “data-OP_{con}”, mentioned above. The data, “data-OP_{con}”, may be entered by a user via the user interface of the management device 4 which stores them in the database 12.

FIGS. 6 to 9 show, by way of an illustrative example, the power profile (“power” graphs) and the corresponding state-of-charge profile (“SoE” graphs) for different related operations.

FIG. 6 shows the power and state-of-charge or energy profiles relating to a first test for complete charging or discharging of a storage module. The operation comprises:
a first step of charging the storage module so that its state of charge or energy (SoE) passes from 0% to 100% with a constant charging power (for example 4 kW), followed by
a second step of discharging the storage module so that its state of charge or energy (SoE) passes from 100% to 0% with a constant discharging power (for example 4 kW).

FIG. 7 shows the power and state-of-charge profiles relating to a second test for complete charging or discharging of a storage module. The operation comprises the following successive steps:
a first step of allowing the storage module to rest at the start of the test;
a second step of charging the storage module so that its state of charge or energy (SoE) passes from 0% to 100% with a variable (random) charging power profile, followed by
a third step of allowing the storage module to rest for a set minimum time period;
a fourth step of discharging the storage module so that its state of charge or energy (SoE) passes from 100% to 0% with a variable (random) discharging power profile;
a fifth step of allowing the storage module to rest at the end of the test.

A rest step is a step during which the storage module is inactive, its charging or discharging power being zero.

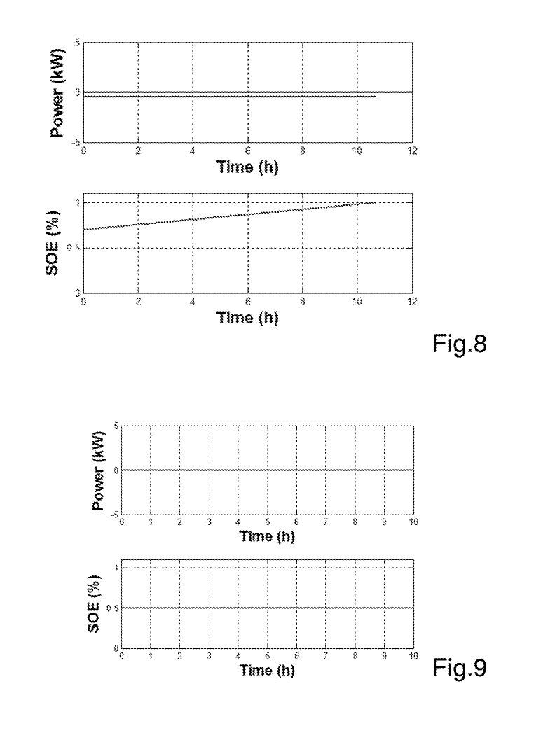

FIG. 8 shows the power and state-of-charge profiles for a related operation involving balancing of a storage module. The balancing operation comprises a single charging step with a very low charging power, for example less than 1 kW, advantageously less than or equal to 0.5 kW. At the start of the operation, the state of charge of the storage module is strictly less than 100%, for example between 50% and 80%. The operation terminates when the state of charge or energy of the module has reached 100%.

FIG. 9 shows the power and state-of-charge profiles for maintenance of a storage module. The operation comprises a single step of inactivity of the storage module for a duration greater than or equal to a limit duration for example of 2 hours. During this time period, the storage module may if necessary be disconnected from the system 1 for a maintenance operation.

The method also comprises a step E2 of recording data relating to the trend of the price of the electricity during the reference period. This price data “data-px” is modelled by the graph px in FIGS. 2 and 3. Said data is recorded in the database 11 of the management device 4, after being entered by a user.

The method also comprises a step E3 of recording data relating to the storage modules “data_batt”. The storage modules, or batteries, 3A-3D, are represented by a set of characteristic data comprising here a maximum (charging or discharging) power, a storage capacity and an initial state of charge. The data relating to the storage modules is stored in the database 11 by the management device 4, for example after being entered by a user or obtained from a test carried out on the module.

The data relating to the estimate of the energy production Pₑₛₜ, the data relating to the storage modules 3A-3D and the data relating to the price of the electricity represent constraints which may be taken into account during the formulation of a production plan of the system 1 by means of optimization.

The method also comprises a step E4 of specifying one or more functions to be optimized to the tool 40 for formulating a production plan. “Functions to be optimized” is understood as meaning an object to be achieved by the system 1 during the production of energy in accordance with the production plan. For example, the following functions may be specified:
a) maximizing the gain on sale of electric energy produced at the output;
b) performing at least one related operation on at least one storage module.

In this case, it is desired that the system 1 should produce energy at the output 6 so as to maximize the gain on sale and perform one or more related operations on one or more storage modules, by means of execution of the production plan during a future period corresponding to the reference period.

Instead of the function b), any other function aiming to incorporate at least one related operation in the operation of one or more storage modules could be specified. For example, the function may be to specify the carrying out of at least one related operation on each storage module.

It is also possible to add the function of maximizing the overall economic value of the related operations incorporated. As explained above, each related operation is associated with an economic value indicating the advantage of carrying out this related operation on an economic level. If several related operations are incorporated in the production plan, the respective economic values of these operations are added together to obtain an overall economic value. In this case, the function is to maximize the overall economic value of the related operations incorporated.

In another example of embodiment, the target function is to carry out a specific related operation specified for one or more particular storage modules, for example following an accident or a production fault.

In any case, in the step E4, the tool 40 of the management device 4 records one or more target functions to be optimized, one at least of these functions being to incorporate at least one related operation in the operation of one or more storage modules. The functions may be specified by a user via the user interface of the management device 4.

During a step E5, the tool 40 of the management device 4 formulates a production plan for the system 1. This production plan is formulated by an optimization process which consists in determining an optimum solution for the function(s) specified during the step E4 taking into account certain constraints. The constraints comprise here the estimation of the power Pₑₛₜ produced by the photovoltaic modules, the price trend of the electricity and the characteristics of the storage modules.

The formulation E5 of the production plan of the system 1 by the management device, as described, incorporates, in a combined manner, at least one related operation on a storage module in the production plan of the system. Thus the formulation of the production plan and the incorporation of one or more related operations on one or more storage modules are performed at the same time. The production plan is formulated incorporating therein one or more related operations on one or more storage modules. In order to incorporate a related operation on a storage module in the production plan, the management device 4 formulates an operation plan for the storage module, including setting to the initial state of charge required for the related operation, a step for execution of the power profile of the related operation and stoppage of the said execution step when a criterion for stoppage of the related operation is satisfied.

An example illustrating a given production plan is shown in FIG. 3. This production plan is adapted here so that the production system 1 introduces the energy into the electric power network 10 almost entirely during the price period which is most profitable for the operator of the system 1 (namely the period during which the price of the electricity on sale is highest), between the instants 50 and 70, in order to optimize the gain on sale of the electricity. According to the production plan, before the instant 50, the near totality of the electric energy produced upstream by the production device 2 is stored in the storage modules 3A-3D so that the overall state of charge increases. Between the instants 50 and 70, the state of charge diminishes since part of the energy introduced into the electric power network comes from the storage modules.

FIG. 4 shows a graph P_{stock} as a broken line corresponding to an overall power plan P_{stock} for all the storage modules 3A-3D. The negative power values correspond to charging values while the positive power values correspond to discharging values. The graph P_{stock} is obtained by determining the difference between the set power P_{cons} of the production plan (FIG. 3) and the estimate of the photovoltaic production Pₑₛₜ (FIG. 2).

During formulation of the production plan, the management device 4 breaks down the overall power plan of the storage modules into the respective individual contributions of the different storage modules 3A-3D. These contributions are represented by individual charging or discharging zones which respectively relate to the different storage modules, as indicated by the key in FIG. 4. The steps for charging and/or discharging a storage module may be linked to normal operation of the module or to a related operation. The management device 4 thus specifies a production forecast plan for each storage module 3A-3D for a future period (corresponding to the reference period). An operation plan comprises a power plan containing data relating to the power trend of the storage module during the reference period. The power plan enables a state-of-charge plan of the storage module to be formulated. Moreover, the operation plan includes a state-of-operation plan containing the different states of operation of the module during the reference period, whereby these states may be a charging state, discharging state, an inactive state, during a related operation. The operation plan also includes the description of the related operation selected by the management device 4 during the step of optimization of the target functions.

Each of FIGS. 5A to 5D shows, for each storage module 3A-3D:
the power plan (“Power” graph in kW) which comprises a time trend graph of the set power of the storage module considered during a reference period;
a state-of-charge plan resulting from this power plan (“SoE” graph in %) and
a state-of-operation plan representing the different successive states of operation of the module during the reference period and including the description of the related operation selected by the management device during the step of optimization of the target functions.

The related operations planned on the storage modules are then carried out during operation of the production system 1, during the course of production based on the established production plan.

In the above description, the incorporation, in the production plan, of the related operations on the storage modules is performed by the management device 4 during formulation of the production plan. By way of a variant, the related operations are incorporated in the production plan afterwards, once the production plan has been established. In this case, in order to incorporate a related operation in the operation of a storage module, the method comprises a step of searching for the specific characteristics of this related operation in the power and state-of-charge plans of the storage module considered. The specific characteristics of the related operation comprise here an initial state-of-charge of the storage module, a power (charging and discharging) profile and a criterion for stoppage of the operation, as explained above.

The method also envisages incorporating a related operation on a storage module by performing charging or discharging compensation with at least one other storage module. For example, it can be seen in FIG. 4 that, between the instants 37 and 40, the storage module 3B performs discharging in order to compensate for charging of the storage module 3A which corresponds to a related operation.

The method may also envisage modifying the production plan within a given tolerance margin in order to facilitate incorporation of a related operation in the production plan.

With reference to FIG. 11, the management device 4 comprises the following elements:
a tool for formulating a production plan 40 which comprises an incorporation module 41 for incorporating related operations on storage modules in the production plan,
the databases 11 and 12,
an interface 42 for connection with the energy production device 2,
an interface 43 for connection with the storage modules 3A-3D and
user interface means comprising for example a display screen 44, an input keyboard 45 and a user interface software module 46 managing data input and display.

The tool 40 comprises an optimization software such as AIMMS®.

Moreover the management device 4 comprises a central control unit 47 to which all the elements 11, 12, 40 to 46 are connected and which is intended to control operation of these elements.

1. Method for managing, using a management device, the energy production of an energy system incorporating an energy production device and a plurality of energy storage modules the method comprising:
formulation, by the management device, of a forecast production plan for production of energy output by the system for a future period,
incorporation, by the management device, of at least one related operation on a storage module in the production plan of the system.

2. The method according to claim 1, wherein the incorporation, in the production plan, of a related operation on a storage module comprises the formulation of a forecast plan for operation of the storage module containing setting to an initial state of charge required for the related operation, execution of a power profile of the related operation and stoppage of the execution when a criterion for stoppage of the related operation is satisfied.

3. The method according to claim 1, comprising recording at least one related operation profile in a database of the management device, the profile containing an initial state of charge required for the storage module, a power profile comprising data relating to the power time trend of the storage module, and a criterion for stoppage of the related operation.

4. The method according to claim 1, wherein the formulation of the production plan and the incorporation of the at least one related operation on a storage module in the production plan of the system are performed in a combined manner.

5. The method according to claim 1, wherein the incorporation of the at least one related operation on the storage module in the production plan of the system is performed after the formulation of the production plan.

6. The method according to claim 1, wherein the formulation of the production plan and the incorporation of the at least one related operation on the storage module in the production plan are performed by the management device via execution of an optimization software.

7. The method according to claim 6, comprising specification of functions to be optimized, at least one of the functions being to incorporate at least one related operation in the operation of at least one storage module.

8. The method according to claim 1, wherein the incorporation of the related operation on the storage module is performed by carrying out charging or discharging compensation with at least one other storage module.

9. The method according to claim 1, wherein the incorporation of the related operation on the storage module is performed by modification of a predetermined production plan within a given tolerance margin.

10. The method according to claim 1, wherein the related operation is selected from the group consisting of:
a first charging capacity test comprising performing complete charging, at constant charging power, of the storage module followed by complete discharging, at constant discharging power, of the storage module,
a second charging capacity test comprising performing complete charging, at several charging power levels, of the storage module followed by complete discharging, at several discharging power levels, of the storage module,
balancing of the storage module comprising charging, at a fixed charging power less than or equal to a maximum power and for a duration greater than or equal to a minimum duration,
a maintenance operation comprising an inactivity of the storage module for a given duration.

11. The method according to claim 1, wherein the energy production device is of the intermittent type and the production plan is established on the basis of an estimate of energy production by the energy production device during the future period.

12. Device for managing an energy production system incorporating an energy production device and a plurality of energy storage modules, comprising a tool for formulation of a forecast plan for production of energy output by the system for a future period, wherein the tool for formulation of the production plan comprises an incorporation module of at least one related operation on a storage module in the production plan of the system.

13. The device according to claim 12, wherein the incorporation module is designed to formulate a forecast plan for operation of the storage module containing setting to an initial state of charge required for the related operation, execution of a power profile of the related operation and stoppage of the execution when a criterion for stoppage of the related operation is satisfied.

14. The device according to claim 12, comprising a database for storing at least one related operation profile, the profile containing an initial state of charge required for the storage module, a power profile comprising data relating to the power time trend of the storage module, and a criterion for stoppage of the related operation.

15. The device according to claim 13, comprising a database for storing at least one related operation profile, the profile containing an initial state of charge required for the storage module, a power profile comprising data relating to the power time trend of the storage module, and a criterion for stoppage of the related operation.

16. The method according to claim 2, comprising recording at least one related operation profile in a database of the management device, the profile containing an initial state of charge required for the storage module, a power profile comprising data relating to the power time trend of the storage module, and a criterion for stoppage of the related operation.

17. The method according to claim 2, wherein the formulation of the production plan and the incorporation of the at least one related operation on the storage module in the production plan of the system are performed in a combined manner.

18. The method according to claim 3, wherein the formulation of the production plan and the incorporation of the at least one related operation on the storage module in the production plan of the system are performed in a combined manner.

19. The method according to claim 2, wherein the incorporation of the at least one related operation on the storage module in the production plan of the system is performed after the formulation of the production plan.

20. The method according to claim 3, wherein the incorporation of the at least one related operation on the storage module in the production plan of the system is performed after the formulation of the production plan.
